(19) United States
(12) Patent Application Publication
(10) Pub. No.: US 2005/0216737 A1
(43) Pub. Date: Sep. 29, 2005

(54) Authentication system

(75) Inventors: Shougo Hayashida, Kanagawa (JP); Osamu Atsumi, Kanagawa (JP)

Correspondence Address: FOLEY AND LARDNER;SUITE 500, 3000 K STREET NW, WASHINGTON, DC, 20007, US

(73) Assignee: SANGIKYO CORPORATION

(21) Appl. No.: 11/088,931

(22) Filed: Mar. 25, 2005

(30) Foreign Application Priority Data
Mar. 26, 2004 (JP) 2004-091274

(51) Int. Cl. H04L 9/00

(52) U.S. Cl. 713/168

(57) ABSTRACT

On the authentication requesting side, two enciphered data y₁ and y₂ are obtained with respect to random number data R₁ and R₂ in two sets, respectively, by executing a predetermined enciphering algorism with at least one predetermined non-laid-open peculiar value N as a parameter, and an exclusive OR value Y is obtained by taking the exclusive OR of the obtained two enciphered data y₁ and y₂ and transmitted together with the random number data R₁ and R₂ in the two sets to the authenticating side. On the authenticating side, two enciphered data y₁ and y₂ are obtained by executing the predetermined enciphering algorithm with the received random number data R₁ and R₂ in the two sets and a peculiar value N preliminarily registered as a non-laid-open value from and based on an initial value of the same value as on the authentication requesting side as parameters, an exclusive OR value Y is obtained by taking the exclusive OR of the obtained two enciphered data y₁ and y₂ and compared with the exclusive OR value Y received from the authentication requesting side, and when the two exclusive OR values Y are identical, an authentication OK decision is made.

### BACKGROUND OF THE INVENTION

This application claims benefit of Japanese Patent Application No. 2004-091274 filed on Mar. 26, 2004, the contents of which are incorporated by the reference.

The present invention relates to authentication systems and, more particularly, to “successful impersonating prevention” and authentication system.

With the development of the ubiquitous society concerning portable telephone sets and PDAs, a variety of communication terminals have been used in a very wide scope. Such a communication field has bearing on many communication terminals such as portable telephone sets, in which fees are charged for communication and data transmission and reception. Also, such services that pertinent communication terminals are used for settling, have been realized.

In the communication terminal having bearing on the fee charging and settling, it is very important and a major preamble that the communication terminal is used by its intrinsic owner. To this end, user authentication is essential, and various means have been proposed as authentication technique. Among such means, portable telephone sets are most popularly used. In this case, if it becomes possible to do “successful impersonating” of the user by a person who is not a true user, it will lead to drastic damages in consideration of the settling function as well. Such a circumstance is brought about by the “successful impersonating” of the user by a person who is not a true user (i.e., user). More accurately, a function as the user's portable telephone set is executed by a portable telephone set owned by a different person. That is, problems are posed by the existence of the so-called clone portable telephone set. Once the existence of such a clone portable telephone set is known (i.e., recognized by the communication dealer), the user himself or herself may avoid the fee charging or settling by the “after-use negation”, i.e., negation of the activity of the user himself or herself after his or her activity. This augments the enlargement of the problems.

In the personal telephone set, usually the user authentication, i.e., authentication of the user himself or herself, is executed. Aside from this authentication, there is message authentication or so-called electronic signature concerning communication contents.

The production of the clone portable telephone set with the aim of “successful impersonating” requires clearing the user authentication techniques and obtaining data necessary for the user authentication.

In the prior art user authentication, an authentication process is executed on the basis of authentication data of the portable telephone set itself and data of the user himself or herself. As portable telephone set authentication data, usually fixed authentication identifier β, for instance given to the pertinent portable telephone set by the portable telephone set manufacturing company, variable authentication identifier α, for instance given to the pertinent portable telephone set by the communication dealer, and various authentication data such as telephone number and IP address given to the pertinent portable telephone set, are set. The flow of giving the authentication data and the flow of communication will now be described with reference to FIG. 3.

Referring to FIG. 3, a manufacturing company 100 for manufacturing portable telephone sets delivers a manufactured portable telephone set with a given fixed authentication identifier, for instance authentication identifier β, via a distributing system B to a communication dealer 200. The communication dealer 200 gives a variable authentication identifier, for instance authentication identifier α, and delivers the resultant set via a distributing system A to a sales shop 300. The sales shop 300 gives a telephone number and an IP address and hands the resultant set over to the user 400. The user 400 uses the portable telephone set, to which various authentication data such as the authentication identifiers α and β, the telephone number and the IP address, for communication and data transmission and reception via a communication line. To this end, the user sends out the authentication data to an authentication server 500 on the communication dealer side for authentication process execution.

In the case of FIG. 3, it is possible that an illegal person gets the authentication identifier β in the inside of the manufacturing company or in the stage of the distributing system B (the possibility of the get in the distributing system B being higher) and also gets the authentication identifier α in the inside of the communication dealer 200 or in the stage of the distributing system A (the possibility of the get in the distributing system A being higher). By considering that the telephone number data and the IP address data are generally laid-open data and readily obtainable, it is possible to produce the so-called clone portable telephone set using various authentication data necessary for the authentication.

Even when it is difficult to get the authentication identifier β from the manufacturing company 100 and the authentication identifier α from the communication dealer 200, it is possible that an illegal person gets the authentication identifier data by tapping or intercepting via the communication line during transmission, via the communication line to the authentication server 500, of the above various authentication data, which are for the authentication process first executed for communication or data communication by the user 400 via the communication line.

To evade the tapping or intercepting of the authentication data transmitted from the portable telephone set via the communication line to the authentication server, a system has been proposed, in which the authentication data to be transmitted is enciphered, and on the authentication server side the enciphered data is deciphered before the authentication process execution.

In such enciphering process, the safety is in many cases determined in dependence on the calculation quantity required for the enciphering and deciphering processes. A great calculation quantity is thus necessary for obtaining the absolute safety to make it impossible to produce the clone portable telephone set. A portable telephone set requiring an enormous calculation quantity of image communication or the like, however, already requires LSI and memory for executing complicated calculations for the processes. Considering the power consumption problems as well, it is difficult to provide high level enciphering requiring great calculation quantity in a portable telephone set, in which the cost reduction, the power saving and the size reduction are most important.

In the portable telephone set, a memory medium (i.e., a ROM) with the authentication data stored therein is mounted. This means that it is possible that the authentication data (i.e., authentication identifiers) are fully stolen from the memory medium and copied. With this copying technique, it is possible to fully steal the authentication identifiers, enciphering algorithm, etc., from the memory medium during the stage of distribution of the portable telephone set from the manufacturer to the use. In such case, enciphering does not provide for any measure against the stealing. With respect to such copying of the recording medium (i.e., ROM), a measure is desired, which makes it impossible to illegally read out the data itself stored in the ROM. However, this solution of the problem is other than the subject matter of the present invention, and is mentioned no more.

As described above, if it is possible to illegally obtain the authentication data, the clone portable telephone set or the like may be produced. This means that in the case of using the function as an electronic purse of a third to fourth generation portable telephone sets, the damage will be expanded not only in the communication fees but also to the general commercial dealings, thus leading to social problems. Also, it is possible that a group which is formed for the purpose of large-scale criminal activities such as narcotic dealings, makes use of the clone portable telephone set to get rid of the tapping or follow-up by the police.

While the above description has been made with respect to the portable telephone set, the above problems also arise in the communication terminal using like system.

As an example of the authentication system in electronic dealings, it is disclosed in Literature 1 (Japanese patent Laid-open 2000-215241) a system, in which a communication terminal transmits a user ID and a password at a predetermined interval, and the sealing system sever side does authentication to prevent such illegal act as double log-in or “successful impersonating” during a dealing.

### SUMMARY OF THE INVENTION

The present invention was made in view of the above problems inherent in the prior art, and its primary object is to provide an authentication system, which makes impossible the tapping or intercepting of authentication data of communication terminals.

Another object of the present invention is to provide an authentication system capable of preventing the production of the clone portable telephone set.

A further object of the present invention is to provide an authentication system capable of preventing the “successful impersonating”.

According to an aspect of the present invention, there is provided an authentication system, wherein: on the authentication requesting side, two enciphered data y₁ and y₂ are obtained with respect to random number data R₁ and R₂ in two sets, respectively, by executing a predetermined enciphering algorism with at least one predetermined non-laid-open peculiar value N as a parameter, and an exclusive OR value Y is obtained by taking the exclusive OR of the obtained two enciphered data y₁ and y₂ and transmitted together with the random number data R₁, and R₂ in the two sets to the authenticating side; and on the authenticating side, two enciphered data y₁ and y₂ are obtained by executing the predetermined enciphering algorithm with the received random number data R₁ and R₂ in the two sets and a peculiar value N preliminarily registered as a non-laid-open value from and based on an initial value of the same value as on the authentication requesting side as parameters, an exclusive OR value Y is obtained by taking the exclusive OR of the obtained two enciphered data y₁ and y₂ and compared with the exclusive OR value Y received from the authentication requesting side, and when the two exclusive OR values Y are identical, an authentication OK decision is made.

According to another aspect of the present invention, there is provided an authentication system, wherein: on the authentication requesting side, two enciphered data y₀₁ and y₀₂ are obtained with respect to initial random number data R₀₁ ad R₀₂ in two sets, respectively, by executing a predetermined enciphering algorithm with at least one predetermined non-laid-open peculiar value No as a parameter, an exclusive OR value Y₀ is obtained by taking the exclusive OR of the obtained random number data R₀₁ ad R₀₂ in the two sets and transmitted together with the random number data R₀₁ ad R₀₂ in two sets to the authenticating side; on the subsequent authentication requesting side, an assigned peculiar value N₁ is obtained by selecting either one of the enciphered data y₀₁ and y₀₂ in a predetermined method, two enciphered data y₁₁ and y₁₂ are obtained with respect to new random number data R₁₁, and R₁₂, respectively, by executing the predetermined enciphering algorithm with the peculiar value N₁ as a parameter, an exclusive OR value Y₁ is obtained by taking the exclusive OR of the obtained two enciphered data y₁₁ and y₁₂ and transmitted together with the random, number data R₁₁, and R₁₂ in the two sets to the authenticating side; on the authenticating side, two enciphered data y₀₁ and y₀₂ are obtained by executing the predetermined enciphering algorithm with the received random number data R₀₁ and R₀₂ in the two sets and a peculiar value N₀ registered as non-laid-open value from and of the same value as on the authentication requesting side, an exclusive OR value Y₀ is obtained by taking the exclusive OR of the obtained two enciphered data y₀₁ and y₀₂ and compared with the exclusive OR value Y₀ received from the authentication requesting side, and when the two exclusive OR values Y₀ are identical, an authentication OK decision is made; and on the subsequent authenticating side, a cascade execution process is executed, in which an assigned peculiar value N₁ is preliminarily obtained by selecting either one of the enciphered data Y₀₁ and y₀₂ in the same method as on the authentication requesting side, two enciphered data y₁₁ and y₁₂ are obtained with respect to the received new random number sets R₁₁, and R₁₂ in the two sets, respectively, by executing the predetermined enciphering algorithm with the peculiar number N₁ as parameter, an exclusive OR value Y₁ is obtained by taking the exclusive OR of the obtained two enciphered data y₁₁ and y₁₂ and compared with the exclusive OR value Y₁ received from the authentication requesting side, and when the two exclusive OR values Y₁ are identical, an authentication OK decision is made.

According to other aspect of the present invention, there is provided an authentication system, wherein: the authentication requesting side comprises: a random number generator for outputting random number data R₁ and R₂ in two sets; an enciphering part for obtaining two enciphered data y₁ and y₂ by executing a predetermined enciphering algorithm with at least one predetermined non-laid-open peculiar data N as a parameter; an exclusive OR part for taking an exclusive OR value Y of the obtained two enciphering data y₁ and y₂; and a transmitting part for transmitting the exclusive OR value Y and the random number data R₁ and R₂ in the two sets to the authenticating side; and the authenticating side comprises: a receiving part for receiving data transmitted from the transmitting part; a deciphering part for obtaining two enciphered data y₁ and y₂ by executing the predetermined enciphering algorithm with the random number data R₁ and R₂ in the two sets and a peculiar value N of the same value as on and registered as non-laid-open value from the receiving part as parameters; an exclusive OR part for outputting an exclusive OR value Y by taking the exclusive OR of the two deciphered data y₁ and y₂ outputted from the deciphering part; and a comparing part for comparing the exclusive OR value obtained in the exclusive OR part and the exclusive OR part received from the authentication requesting side and, when the two exclusive OR values are identical;, making an authentication OK decision.

According to further aspect of the present invention, there is provided an authentication system, wherein on the subsequent authentication requesting side according to claim 2, an assigned peculiar value N₂ is obtained by selecting either one of the enciphered data y₁₁ and y₁₂, two enciphered data y₂₁ and y₂₂ are obtained with respect to the new random number data R₂₁ and R₂₂ in the two sets, respectively, by executing the predetermined enciphering algorithm with the peculiar value N₂ as a parameter, an exclusive OR value Y₂ is obtained by taking the exclusive OR of the obtained two enciphering data y₂₁ and y₂₂ and transmitted together with the random number data R₂₁ and R₂₂ in the two sets to the authenticating side; and on the subsequent authenticating aside, an assigned peculiar value N₂ is obtained by selecting either one of the enciphered data y₁₁, and y₁₂ in the same method as on authentication requesting side, two enciphered data y₂₁ and y₂₂ are obtained with respect to the received new random number data R₂₁ and R₂₂ in the two sets, respectively, by executing the predetermined enciphering algorithm with the peculiar value N₂ as a parameter, an exclusive OR value Y₂ is obtained by taking the exclusive OR of the obtained two enciphered data y₂₁ and y₂₂, and when the two exclusive OR value Y₂ are identical, an authentication OK decision is made.

The initial peculiar value N₀ is known to only the authentication requesting side and the authenticating side, and is non-laid-open data. The peculiar value N₀ is an ID (identifier) predetermined for each authentication requester. The data transfer between the authentication requesting side and the authenticating side is made via a communication line. The peculiar value N₀ is a peculiar value predetermined for each portable telephone set. The subject of authentication is a communication terminal. The subject of authentication is a communing party for doing communication. The predetermined enciphering algorithm is a one-way function operating system. The one-way function operating system is executed such that, denoting random numbers in two different sets by R₁ and R₂, respectively, a peculiar number by N and enciphered data by y₁ and y₂, the enciphered data y₁ and y₂ are obtained by executing
y₁=(R₂+N) mod N R₁>N and
y₂=(R₂+N) mod N R₂>N,
an exclusive OR value Y is obtained by taking the exclusive OR value Y of the obtained enciphered data y₁, and y₂, Y′ is obtained by reducing the bit number of the obtained exclusive OR value Y in a predetermined method, and it is defined that, with the random numbers R₁ and R₂ as well-known values, a calculation of obtaining Y′ from N is a forward calculation and a calculation of obtaining N from Y′ is a converse calculation, whereby although the forward calculation can be readily made, the converse calculation of obtaining N from Y′, obtained by reducing the bit number of the exclusive OR value Y in the predetermined method, is impossible because of non-existence of any calculation formula to this end, thereby preventing the tapping of or swindling on the peculiar value N.

According to still further aspect of the present invention, there is provided an authentication system , wherein: on the authentication requesting side, two enciphered data y₁ and y₂ are obtained with respect to random number data R₁ and R₂ in two sets, respectively, by executing a predetermined enciphering logarithm with at least one predetermined non-laid-open peculiar number N of at least two hexadecimal system bits and with one assigned to the most significant binary system bit as a parameter, an exclusive OR value Y is obtained by taking the exclusive OR of the two enciphered data y₁, and y₂, and authentication enciphered data Y′ is obtained by reducing the bit number of the obtained exclusive OR value Y in a predetermined method and transmitted together with the random number data R1 and R1 in the two sets to the authenticating side; and on the authenticating side, two enciphered data y₁ and y₂ are obtained by executing the predetermined enciphering algorithm with the received random number data R₁ and R₂ in the two sets and a peculiar value N preliminarily registered as non-laid-open value from and based on an initial value of the same value as on the authentication requesting side as parameters, an exclusive OR value Y is obtained by taking the exclusive OR value of the obtained two enciphered data y₁, and y₂, an authentication discriminative data Y′ is obtained by reducing the bit number of the obtained exclusive OR value in the same predetermined method as on the authentication requesting side and compared with the authentication enciphered data Y′ received from the authentication requesting side, and when the two compared data Y′ are identical, an authentication OK decision is made.

According to other aspect of the present invention, there is provided an authentication system, wherein: on the authentication requesting side, two enciphered data y₀₁ and y₀₂ are obtained with respect to initial random number data R₀₁ and R₀₂ in two sets, respectively, by executing a predetermined enciphering algorithm with at least one predetermined non-laid-open peculiar value N₀ of at least two hexadecimal system bits and with one assigned to the most significant binary system bit as parameter, an exclusive OR value Y₀ is obtained by taking the exclusive OR of the obtained two enciphered data y₀₁ and Y₀₂, and an authentication enciphered data Y₀′ is obtained by reducing the bit number of the obtained exclusive OR value Y₀ in a predetermined method and is transmitted together with the random number data R₀₁ and R₀₂ in the two sets to the authenticating side; on the subsequent authentication requesting side, a peculiar value N₁ is obtained by selecting either one of the two enciphered data y₀₁ and y₀₂ in a predetermined method, converting the selected data to a binary value and always assigning one to the most significant bit thereof, two enciphered data y₁₁ and y₁₂ are obtained with respect to new random number data R₁₁ and R₁₂ in two sets, respectively, by executing the predetermined enciphering method with the peculiar value N₁ as a parameter, an exclusive OR value Y₁ is obtained by taking the exclusive OR of the two enciphered data y₁₁ and y₁₂, and exclusive OR data Y₁ is obtained by reducing the bit number of the obtained exclusive OR value Y₁ in a predetermined method and is transmitted together with the random number data R₁₁ and R₁₂ in the two sets to the authenticating side; on the authenticating side, two enciphered data y₀₁ and y₀₂ are obtained by executing the predetermined enciphering algorithm with the received random number data R₀₁ and R₀₂ in the two sets and a peculiar value N₀ registered as non-laid-open value from and of the same value as on the authentication requesting side as parameters, an exclusive OR value Y₀ is obtained by taking the exclusive OR of the obtained two enciphered data y₀₁ and y₀₂, authentication discriminative data Y₀′ is obtained by reducing the bit number of the obtained exclusive OR value Y₀ in the same predetermined method as on the authentication requesting side and is compared with the authentication enciphering data Y₀′ received from the authentication requesting side, and when the two data are identical, an authentication OK decision is made; and on the subsequent authenticating side, a cascade execution process is made, in which the peculiar value N₁ is obtained by selecting either one of the two enciphered data y₀₁ and y₀₂ in the same predetermined method as on the authentication requesting side, converting the selected data to a binary value and always assigning one to the most significant bit, two enciphered data y₁₁ and y₁₂ are obtained with respect to the received new random number data R₁₁ and R₁₂, respectively, with the peculiar value N₁ as a parameter, an exclusive OR value Y₁ is obtained by taking the exclusive OR of the obtained two enciphered data y₁₁ and y₁₂, authentication discriminative data Y₁′ is obtained by reducing the bit number of the obtained exclusive OR value Y₁ in the same predetermined method as on the authentication requesting side and compared with the authentication enciphered data Y₁′ received from the authentication requesting side, and when the two authentication discriminative data Y₁′ are identical, an authentication OK decision is made.

Other objects and features will be clarified from the following description with reference to attached drawings.

### BRIEF DESCRIPTION OF THE DRAWINGS

FIG. 1 is a block diagram showing the transmitting side as authentication requesting side in an embodiment of the authentication system according to the present invention;

FIG. 2 is a block diagram showing the authenticating side of the embodiment according to the present invention; and

FIG. 3 shows a flow of giving the authentication data and the communication.

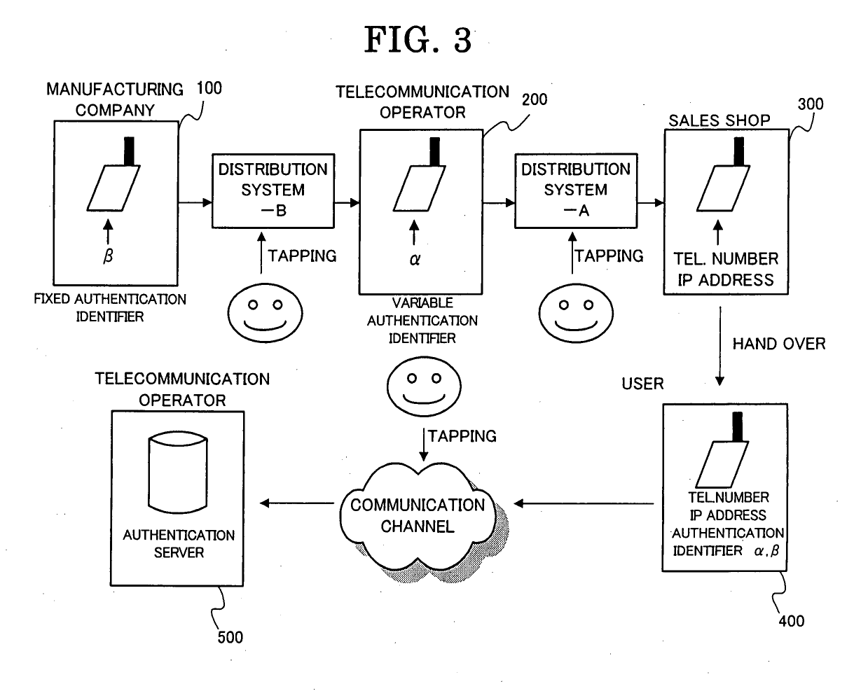

### PREFERRED EMBODIMENTS OF THE INVENTION

Preferred embodiments of the present invention will now be described with reference to the drawings.

An authentication system of an embodiment according to the present invention will be described.

As stated before, in the usual user authentication technique, as a means for avoiding the intercepting and deciphering in the communication line, the enciphered data for authentication to be transmitted is obtained by enciphering with a high level enciphering technique based on the safety in view of the calculation quantity. In contrast, according to the present invention the authentication enciphered data is replaced with random numbers for communication, and opposite side confirmation authentication algorithms extracted from the random numbers are each made to be one-time consumable by cascade relating from the outside of the first time of communication. Consequently, the trying of the opposite side confirmation authentication algorithm by intercepting the algorithm via the communication line, will be absolutely in vein because the relation between the transmitted random numbers R₁ and R₂ and the authentication enciphered data Y′ is a relation between random number and random number without presence of any algorithm. The transmission of the authentication enciphered data itself to the communication line without enciphering is possible. Also, even when the “successful impersonating” is tried by imitating the numerical values of the random number data R₁ and R₂ and the authentication enciphered data Y′, it is logically impossible to succeed in the “successful impersonating” except for that it happens that an identical relation between the random numbers R₁ and R₂ and the authentication enciphered data Y′ is obtained. The probability that it happens that an identical relation between the random numbers R₁ and R₂ and the authentication enciphered data Y′ is obtained, is inversely proportional to the round bobbin number of the binary values of the random numbers R1 and R2 and the authentication enciphering data Y′. In other words, it is possible to substantially perfectly prevent the “successful impersonating” based on occasional happening by selecting the random numbers R₁ and R₂ and the authentication enciphered data Y′ such that the product of multiplication of all the random numbers R₁ and R₂ and the authentication enciphered data Y′ is of at least 128 bits.

In the user authentication, as for the one-time consumable opposite side confirmation authentication signal the past communication history is fully and continuously recorded and managed, and it is avoided to repeatedly use the same one-time opposite side confirmation authentication signal. According to the present invention, the authentication enciphered data is replaced with random numbers for communication, and opposite side confirmation authentication algorithms extracted from the random numbers are each made to be one-time consumable by cascade relating from the outset of the communication. Thus, instead of continuously recording and managing all the past communication history, it is possible to establish a one-time opposite side confirmation authentication signal by recording the immediately preceding fixed peculiar value N. As a result, the memory capacity may be saved and the programs may be simplified.

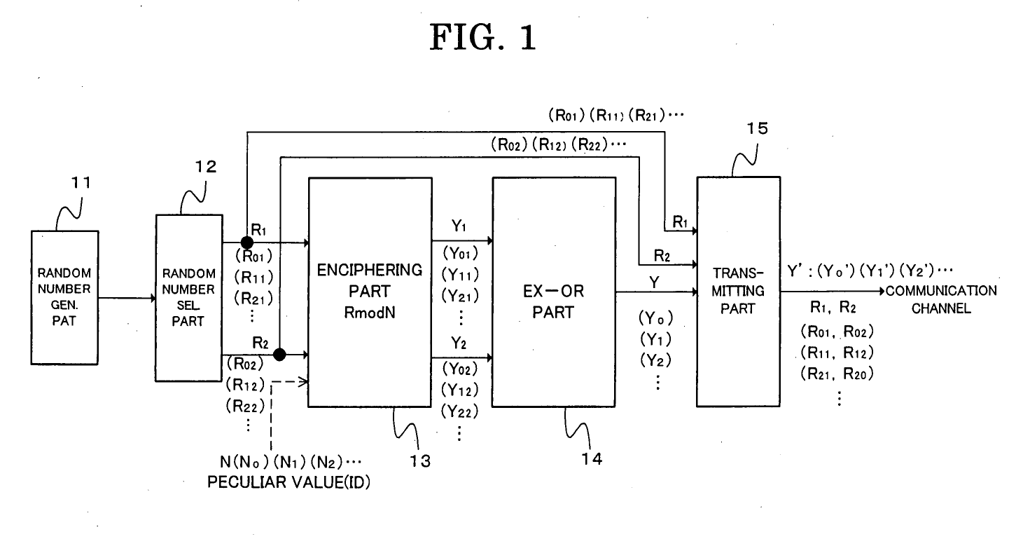

FIG. 1 is a block diagram showing the transmitting side as authentication requesting side in an embodiment of the authentication system according to the present invention.

In this embodiment, the authentication requesting side, i.e., transmitting side, comprises a random number generator 11, a random number selector 12, an enciphering part 13, an exclusive OR (EX−OR) part 14 and a transmitting part 15.

The random number selector 12 selects and outputs desired random number data among the random numbers, i.e., two random numbers R₁ and R₂, generated in the random number generator 11. As the random number data R₁ and R₂, random number data of, for instance, 256 bits are outputted as two sets of data among the random numbers generated in the random number generator 11. The random number selector 12 may not be necessary so long as random number data R₁and R₂in two different sets are obtainable. Here, intrinsic random numbers are preferred, but pseudo random numbers are applicable as well.

The enciphering part 13 receives, as parameters, the random number data R₁ and R₂ in the two sets outputted from the random number selector 12 and an at least one predetermined peculiar value N of, for instance, 128 bits and with binary system one assigned as most significant bit numerical value. The enciphering part 13 then obtains enciphered data y₁ and y₂, which are enciphered by executing a predetermined enciphering algorithm, for instance one-way functions given by the following equations (1) and (2), and obtains an exclusive OR value Y by taking the exclusive OR of the obtained enciphered data y₁ and y₂. The enciphering part 13 then reduces the bit number of the obtained exclusive OR value in a predetermined method to obtain authentication enciphered data Y′ for transmission thereof together with the random number data R₁ and R₂ in the two sets to the authenticating side as receiving side.
y₁=(R₁+N) mod N R₁>N (1) and
y₂=(R₂+N) mod N R₂>N (2).

The authentication enciphered data Y′ and the random number data R₁ and R₂ in the two sets, obtained as in the above, are transmitted from the transmitting part 15 to the communication line.

The arrangement and operation of the transmitting side shown in FIG. 1 will now be described in greater details.

Initial random number data R₀₁ and R₀₂, for instance of 256 bits, in two different sets generated in the random number generator 11, are outputted to the enciphering part 13. To the enciphering part 13 is inputted as a parameter a peculiar number N₀ of an authentication requesting side of, for instance, 128 bits and with binary system one assigned as the most significant bit numerical value. As the peculiar value Nₒ, may be used an ID (authentication identifier).

The enciphering part 13 executes the function calculation as given by the above equations (1) and (2) by using the random number data R₀₁ and R₀₂ and the peculiar value N₀. It is made that peculiar number N₀<random number data R₀₁ or R₀₂.

As a result, enciphered data y₀₁ and y₀₂ given by the following equations (3) and (4) are obtained with respect to the above random number data R₀₁ and R₀₂, respectively.
y₀₁=(R₀₁+N₀) mod N₀ (3), and
y₀₂=(R₀₁+N₀) mod N₀ (4)

The exclusive OR part 14 executes a process of taking the following exclusive OR of the obtained enciphered data y₀₁ and y₀₂ to obtain an exclusive OR value Y₀, and reduces the bit number thereof in a predetermined method to obtain authentication enciphered data Y₀′.
Y=y₀₁(EX−OR)y₀₂ (5).

Here, y₀₁ (EX−OR) y₀₂ represents the exclusive OR of Y₀₁ and y₀₂.

The authentication enciphered data Y₀′ and the random number data R₀₁ and R₀₂ in the two sets are transmitted via the communication line to the authenticating side. The authentication enciphered data Y₀′ is a one-way opposite side confirmation authentication signal.

The authenticating side receives the random number data R₀₁ and R₀₂ and the peculiar value N₀ transmitted from the authentication requesting side. The peculiar value N₀ is delivered as non-laid-pen value to the authenticating side without agency of any other party, such as by handing-over, while the random number data R₀₁ and R₀₂ are transmitted via the communication line.

In the system with the present invention applied thereto, the above equations (1) and (2) are used between the authentication requesting side and the authenticating side are preliminarily set up and known to both sides. Since the peculiar value N₀ and the random number data R₀₁ and R₀₂ are also known, the authenticating side can execute the authentication requesting side function calculations of the equations (3) and (4) to obtain the enciphered data y_{01 and y}₀₂.

The enciphered data y₀₁ and y₀₂ thus obtained are used to obtain the exclusive OR value Y₀ according to the equation (5). The obtained exclusive OR value Y₀ is subjected to bit number reduction in the same predetermined method as on the authentication requesting side to obtain the authentication discrimination data Y₀′. On the authenticating side, when it is found that the received authentication enciphered data Y₀′ and the authentication enciphered data Y₀′ obtained by executing the exclusive OR of the obtained enciphered data y₀₁ and y₀₂ to obtain the exclusive OR value and reducing the bit number thereof in the same method as on the authentication requesting side are identical, this shows that the parameters confidentially held between the authentication requesting side and the authentication side are identical. Thus, the authenticating side can authenticate that the authentication requester is the true one.

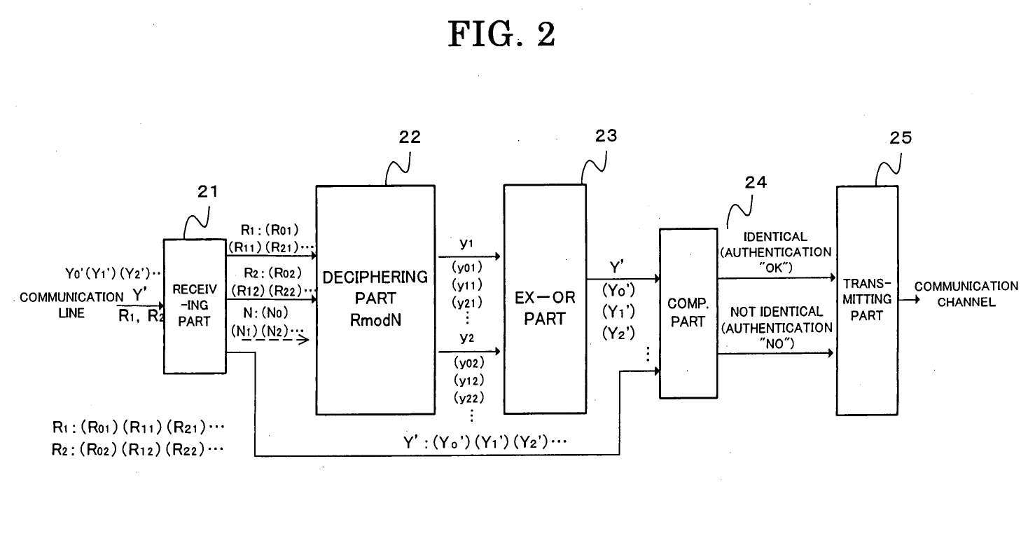

FIG. 2 is a block diagram showing the authenticating side for executing the above operation.

A receiving part 21 receives the authentication enciphering data Y₀′ and the random number data R₀₁ and R₀₂ transmitted via the communication line. A deciphering part 22 executes calculations of the equations (3) and (4) on the basis of the peculiar value N₀ and the random number data R₀₁ and R₀₂ to obtain the enciphered data y₀₁ and y₀₂, respectively. Using the obtained enciphered data y₀₁ and y₀₂, an exclusive OR part 23 executes the exclusive OR calculation with the equation (5) to obtain the exclusive OR value Y₀, and reduces the bit number thereof in the same predetermined method as on the authentication requesting side to obtain the authentication enciphered data Y₀′. A comparing part 24 compares the obtained authentication enciphered data Y₀′ and the authentication enciphered data Y₀ received in the received part 21. When the two compared values are identical, the comparing part 24 makes an authentication OK decision, that is, decides that the authentication requester is the real one. When the two values are not identical, the comparing part 24 does not make any authentication OK decision but decides that the authentication requester is not the real one. A transmitting part 25 transmits the authentication decision via the communication line to the authentication requesting side.

It is preliminarily agreed between the authentication requesting side and the authenticating side that either one of the enciphered data y₀₁ and y₀₂ is to be used as peculiar value N₁ as the next time of authentication. For example, the enciphered data y₀₁ is used as the peculiar value N₁ to be selected on the authentication requesting side at the next time of authentication. As the initial value N, the peculiar value N₀ is set to be, for instance, a 128-bit value such as the authentication requester's ID with binary system one assigned as the most significant bit numerical value. To make the next and following values N to be of the same bit number as the initial peculiar value N₀, fixed value one is assigned to the most significant binary system bit of the selected enciphered data y₀₁ to obtain the second peculiar value N₁. The same process is executed for the following values N as well. This process is executed in both the authentication requesting side and the authenticating side. In the subsequent actual time of use, in the n-th authentication process from the outset, the enciphered data y(ₙ₋₁)₁ used in the immediately preceding process is used.

In the next, i.e., second, authentication timing, on the authentication requesting side the enciphering part 13 is given enciphered data y₀₁ as peculiar value N₁ and takes out random number data R₁₁ and R₁₂ from the random number generator 11, and obtains enciphered data y₁₁ and y₁₂ in the following equations (6) and (7) like the above equations (3) and (4).
y₁₁=(R₁₁+N₁) mod N₁R₁₁>N₁ (6) and
y₁₂=(R₁₂+N₁) mod N₁R₁₂>N₁ (7)

The exclusive OR part 14 executes the exclusive OR calculation on the enciphered data y₁₁ and y₁₂ thus obtained in the following equation (8) to obtain an exclusive OR value Y₁. The obtained exclusive OR value Y₁ is subjected to bit number reduction in a predetermined method, thereby obtaining authentication enciphered data Y₁′ to be finally transmitted.
Y₁=y₁₁ (EX−OR)y₁₂ (8)

Thus, the transmitting side 15 on the authentication requesting side obtains a peculiar value N₁ by assigning binary system one as most significant bit numerical value in the data y₀₁ obtained in the equation (3), obtains the exclusive OR value Y₁ based on the random number data R₁₁ and R₁₂ in the two sets and the above equation (8), and obtains authentication enciphering data Y₁′ by reducing the bit number of the exclusive OR value Y₁ for transmitting the data Y₁′ via the communication line to the authenticating side.

On the authenticating side, the receiving part 21 receives the random number data R₁₁ and R₁₂ and the peculiar value N₁, which has been obtained as a result of the selection, on the authenticating side and in the above equation (3), of the same enciphered data y₀₁ as the one selected on the authentication requesting side, conversion of the selected enciphered data y₀₁ to a binary value, and assigning to the binary value that the most significant bit is always one. The deciphering part 22 obtains the enciphered data y₁₁ an y₁₂ from the above data according to the above equations (6) and (7). The exclusive OR part 23 executes the exclusive OR process on the obtained enciphered data R₁₁ and R₁₂ according to the equation (8) to obtain the exclusive OR value Y₁. The exclusive OR value Y₁is subjected to bit number reduction in the same predetermined method as on the authentication requesting side to obtain the authentication identifying data Y1′.

The comparing part 24 compares the authentication identifying data Y₁′ obtained in he exclusive OR part 23 and the authentication enciphered data Y₁′ received on the authenticating data from the receiving part 21 on the authentication requesting side. When the comparing part 24 finds that the two values are identical, it makes an authentication OK decision, i.e., decides that the authentication requester is the true one. When the comparator 24 fails to find the identify, it does not make any authentication OK decision, i.e., decides that the authentication requester is not the true one. The transmitting part 25 transmits the authentication decision result via the transmitting line to the authentication requesting side.

Like authentication process is executed in the following authentication processes.

For instance, in the third authentication timing, the authentication requesting side likewise uses the enciphered data y₁₁ obtained at the immediately preceding time of authentication as peculiar value N₂ for the present authentication. The enciphering part 23 takes out the random number data R₂₁ and R₂₂ in the two sets from the random number generator 11 and, like the above case of the equations (3) and (4), obtains enciphered data y₂₁ and y₂₂ from the equations (9) and (10).
y₂₁=(R₂₁+N₂) mod N₂R₂₁>N₂ (9), and
y₂₂=(R₂₂+N₂) mod N₂R₂₂>N₂ (10)

The exclusive OR part 14 executes the exclusive OR calculation of the two enciphered data y₂₁ and y₂₂ thus obtained according to the following equation (11) to obtain an exclusive OR value Y₂. The obtained exclusive OR value Y₂ is subjected to bit number reduction by a predetermined method to obtain authentication enciphered data Y₂′ to be finally transmitted.
Y₂=y₂₁(EX−OR)y₂₂ (11)

The transmitting side 15 on the authentication requesting side transmits the random number data R₂₁ and R₂₂ and the authentication enciphered data Y₂′, which has been obtained by reducing the bit number of the exclusive OR value Y₂, obtained according to the above equation (11), in a predetermined method, via the communication line to the authenticating side.

On the receiving side as authenticating side, the receiving part 21 receives the random number data R₂₁ and R₂₂ and a peculiar number N₂, which has been obtained as a result of selection, on the authentication requesting side, of the same enciphered data y₁₁ as the one selected on the authentication requesting side, conversion of the selected enciphered data y₁₁ to a binary value and assigning to the binary value that the most significant bit is always one. The deciphering part 22 obtains enciphered data y₂₁ and y₂₂ from the above data according to the above equations (9) and (10). The exclusive OR part 23 executes an exclusive OR process on the obtained enciphered data y₂₁ and y₂₂ according to the equation (11) to obtain an exclusive OR value Y₂. The exclusive OR value Y₂ thus obtained is subjected to bit number reduction in the same predetermined method as on the authentication requesting side to obtain authentication identifying data Y₂′.

The comparing part 24 compares the authentication identifying data Y₂′ thus obtained in the exclusive OR part 23 and the authentication enciphered data Y₂′ transmitted from the authentication requesting side and received in the receiving part 21. When the comparing part 24 finds that the two values are identical, it makes an authentication OK decision, i.e., decides that the authentication requester is the true one. When the comparing part 24 fails to find the identity, it does not make any authentication OK decision, i.e., decides that the authentication requester is other than the true one. The transmitting part 25 transmits the authentication decision result via the communication line to the authentication requesting side.

The above process is executed between the authentication requesting side and the authenticating side for each authentication request.

In the above system, the predetermined enciphering algorithm defines two, i.e., forward and reverse, calculations. The forward calculation is to obtain the value Y′ from the peculiar value N, which is a hexagonal system number of two or more bits and is obtained with such an assignment that the most significant binary system bit is always one, by substituting N into two same functions with random number values R₁ and R₂ in two sets as known values to obtain two calculation process values y₁ and y₂, taking the exclusive OR of the values y₁ and y₂ to obtain an exclusive OR value Y, converting Y to a binary value, and reducing the bit number thereof in a predetermined method. The reverse calculation is to obtain the peculiar value N from the value Y′ obtained in the forward calculation by substitution of the random numbers R₁ and R₂ in the two sets. In the calculation of obtaining Y′ from N by reducing the binary system bit number of the exclusive OR value Y obtained as a result of execution of the exclusive OR, a one-way non-reversible relation holds. That is, while the calculation is forwardly possible, it is reversely impossible. Even when it is tried to obtain the peculiar value in the calculation method based on the round bobbin method, a plurality of values are obtained. It is thus impossible to provisionally confirm the peculiar value N.

In the case of selecting y₀₁ to y(ₙ₋₁)₁ as data N₁ to Nₙ as cascade substitution consumable data, since R₀₁ to R(ₙ₋₁)₁ are random numbers, the signals y₀₁ to y(ₙ₋₁)₁ are also random numbers, and the bit number of N is varied. In other words, when it happens that zero is generated as an upper bit of the numerical value of y, the bit number of N is reduced. With the N bit number reduction, the bit number of y is correspondingly reduced, and the initial bit numbers of N and y are no longer restored. In consequence, the values of N₁, y₁, Y and Y′ all become zero, the function as the opposite side confirmation authentication signal disappears, and the initial bit numbers are no longer restored as the values of N₁, y₁, Y and Y′. The bit numbers of N₁, y₁, Y and Y′ are held constant the numerical value of y is assigned as the numerical value of N in coincidence with changes in the numerical value of y. More specifically, the numerical values of the second and lower bits from the most significant bit of y₀₁ to y(ₙ₋₁)₁ with such assignment that the most significant bit of the binary system value of y is always one, are assigned subsequent to the most significant binary system bit numerical value of N₁ to Nₙ in coincidence with changes in the numerical value of y₀₁ to y(ₙ₋₁)₁.

While the above description of the above embodiment has concerned with the general authentication process, it will be readily understood that the present invention is applicable as well to the authentication process in the above portable telephone set. In other words, it is possible to use the special peculiar data ID of the portable telephone set owner as N value to be set at the outset.

As has been described in the foregoing, according to the present invention in the one-way opposite side confirmation authentication (i.e., one-way functions), it is possible to ensure one-way non-reversible character by the authentication enciphered data Yₙ′, which is obtained by obtaining the enciphered data y₀₁ and y₀₂ obtained by executing the function calculation of the equations (3) and (4) with respect to the independently generated random number data R₀₁ and R₀₂ in two sets, obtaining the exclusive OR value Y₀ by executing the exclusive OR process on the obtained enciphered data y₀₁ and y₀₂ according to the equation (5) and subjecting Y₀ thus obtained to bit number reduction in a predetermined method. Also, an agreement is made between the authentication requester and the authenticator that, at the first time of registration the peculiar number N₀ such as ID of the authentication requester is confidentially handed over to and registered on the authenticating side, and at the second and further times of authentication use is made of preliminarily agreed enciphered data (for instance y₀₁) obtained at the time of the immediately preceding process. Thus, only the authentication enciphered data Y₀′ and the two different random number data R₀₁ and R₀₂ are transmitted from the authentication request side to the authentication side. These data themselves are not in any algorithm relation to one other at all. That is, even these data are tapped from the communication line, the “impersonation” is very difficult. In other words, the peculiar value N is cascade-wise related data continuous from the confidential data such as the initial peculiar value N₀ and the authentication requester's ID. It is thus possible to prevent the “impersonation” by any impertinent person without need of recording and managing the past communication history but by merely recording and managing only the peculiar value used in the immediately preceding authentication process.

With the authentication system according to the present invention, the following pronounced practical advantages are obtainable. Usual signals for authentication are transmitted after enciphering with high level enciphering techniques depending on the safety based on the calculation quantity. According to the present invention, the enciphered signals for authentication are transmitted after replacement with random numbers. From the random numbers, opposite side confirmation authentication algorithms are extracted, respectively, which are each related in one time consumable in cascade relating from the outset of the first time of communication. Consequently, when opposite side confirmation authentication algorithm deciphering is tried by intercepting the algorithm via the communication line, this is utterly unsuccessful because the relation between transmitted random number and enciphered signal for authentication is a relation between random number and random number without presence of any algorithm. For this reason, the authentication enciphered signals themselves can be transmitted without enciphering to the communication line. In this circumstance, an illegal person may try the “imprisoning” with a so-called clone portable telephone set, which has been produced by illegally copying and stealing the authentication identifiers and the opposite side confirmation authentication algorithm of a portable telephone set from the memory medium (i.e., ROM) thereof in the manufacturer or during the distribution. However, the opposite side confirmation authentication algorithm is related in cascade relating. This means that the illegal person has to continuously and fully steal the authentication enciphered data from the outset of the communication, accumulate the stolen data in a database and analyze the data. Therefore, the “impersonating” is extremely difficult. Even when the illegal person has succeeded in the “successful impersonating” by using a clone portable telephone set, the user's portable telephone set becomes invalid at the time of execution of the “successful impersonating” by the illegal person. The user thus becomes aware of the fact that “successful impersonating” has been done, leading the difficulty of continuous execution of the “successful impersonating” by the illegal person.

In the user authentication, as for the one-time consumable opposite side confirmation authentication signal, it is avoided to repeatedly use the same one-time opposite side confirmation authentication signal by continuously recording and managing all the past communication history. According to the present invention, instead of continuously recording and managing all the past communication history, it is possible to establish a one-time consumable opposite side confirmation authentication signal by recording the immediately preceding peculiar value N. It is thus possible to save the memory in the communication dealer's authentication server and simplify the program.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. An authentication system, wherein:
on an authentication requesting side, two enciphered data y₁ and y₂ are obtained with respect to random number data R₁ and R₂ in two sets, respectively, by executing a predetermined enciphering algorithm with at least one predetermined non-laid-open peculiar value N as a parameter, and an exclusive OR value Y is obtained by taking the exclusive OR of the obtained two enciphered data y₁ and y₂ and transmitted together with the random number data R₁ and R₂ in the two sets to the authenticating side; and
on an authenticating side, two enciphered data y₁ and y₂ are obtained by executing the predetermined enciphering algorithm with the received random number data R₁ and R₂ in the two sets and a peculiar value N preliminarily registered as a non-laid-open value from and based on an initial value of the same value as on the authentication requesting side as parameters, an exclusive OR value Y is obtained by taking the exclusive OR of the obtained two enciphered data y₁ and y₂ and compared with the exclusive OR value Y received from the authentication requesting side, and when the two exclusive OR values Y are identical, an authentication OK decision is made.

2. An authentication system, wherein:
on an authentication requesting side, two enciphered data y₀₁ and y₀₂ are obtained with respect to initial random number data R₀₁ ad R₀₂ in two sets, respectively, by executing a predetermined enciphering algorithm with at least one predetermined non-laid-open peculiar value No as a parameter, an exclusive OR value Y₀ is obtained by taking the exclusive OR of the obtained random number data R₀₁ ad R₀₂ in the two sets and transmitted together with the random number data R₀₁ ad R₀₂ in two sets to the authenticating side;
on a subsequent authentication requesting side, an assigned peculiar value N₁ is obtained by selecting either one of the enciphered data y₀₁ and y₀₂ in a predetermined method, two enciphered data y₁₁ and y₁₂ are obtained with respect to new random number data R₁₁ and R₁₂, respectively, by executing the predetermined enciphering algorithm with the peculiar value N₁ as a parameter, an exclusive OR value Y₁ is obtained by taking the exclusive OR of the obtained two enciphered data y₁₁ and Y₁₂ and transmitted together with the random, number data R₁₁ and R₁₂ in the two sets to the authenticating side;
on an authenticating side, two enciphered data y₀₁ and y₀₂ are obtained by executing the predetermined enciphering algorithm with the received random number data R₀₁ and R₀₂ in the two sets and a peculiar value N₀ registered as non-laid-open value from and of the same value as on the authentication requesting side, an exclusive OR value Y₀ is obtained by taking the exclusive OR of the obtained two enciphered data y₀₁ and y₀₂ and compared with the exclusive OR value Y₀ received from the authentication requesting side, and when the two exclusive OR values Y₀ are identical, an authentication OK decision is made; and
on a subsequent authenticating side, a cascade execution process is executed, in which an assigned peculiar value N₁ is preliminarily obtained by selecting either one of the enciphered data y₀₁ and y₀₂ in the same method as on the authentication requesting side, two enciphered data y₁₁ and y₁₂ are obtained with respect to the received new random number sets R₁₁ and R₁₂ in the two sets, respectively, by executing the predetermined enciphering algorithm with the peculiar number N₁ as parameter, an exclusive OR value Y₁ is obtained by taking the exclusive OR of the obtained two enciphered data y₁₁ and y₁₂ and compared with the exclusive OR value Y₁ received from the authentication requesting side, and when the two exclusive OR values Y₁ are identical, an authentication OK decision is made.

3. An authentication system, wherein:
an authentication requesting side comprises:
a random number generator for outputting random number data R₁ and R₂ in two sets;
an enciphering part for obtaining two enciphered data y₁ and y₂ by executing a predetermined enciphering algorithm with at least one predetermined non-laid-open peculiar data N as a parameter;
an exclusive OR part for taking an exclusive OR value Y of the obtained two enciphering data y₁ and y₂; and
a transmitting part for transmitting the exclusive OR value Y and the random number data R₁ and R₂ in the two sets to the authenticating side; and
an authenticating side comprises:
a receiving part for receiving data transmitted from the transmitting part;
a deciphering part for obtaining two enciphered data y₁ and y₂ by executing the predetermined enciphering algorithm with the random number data R₁ and R₂ in the two sets and a peculiar value N of the same value as on and registered as non-laid-open value from the receiving part as parameters;
an exclusive OR part for outputting an exclusive OR value Y by taking the exclusive OR of the two deciphered data y₁ and y₂ outputted from the deciphering part; and
a comparing part for comparing the exclusive OR value obtained in the exclusive OR part and the exclusive OR part received from the authentication requesting side and, when the two exclusive OR values are identical; making an authentication OK decision.

4. An authentication system according to claim 2, wherein
on a subsequent authentication requesting side, an assigned peculiar value N₂ is obtained by selecting either one of the enciphered data y₁₁ and y₁₂, two enciphered data y₂₁ and y₂₂ are obtained with respect to the new random number data R₂₁ and R₂₂ in the two sets, respectively, by executing the predetermined enciphering algorithm with the peculiar value N₂ as a parameter, an exclusive OR value Y₂ is obtained by taking the exclusive OR of the obtained two enciphering data y₂₁ and y₂₂ and transmitted together with the random number data R₂₁ and R₂₂ in the two sets to the authenticating side; and
on a subsequent authenticating aside, an assigned peculiar value N₂ is obtained by selecting either one of the enciphered data y₁₁ and y₁₂ in the same method as on authentication requesting side, two enciphered data y₂₁ and y₂₂ are obtained with respect to the received new random number data R₂₁ and R₂₂ in the two sets, respectively, by executing the predetermined enciphering algorithm with the peculiar value N₂ as a parameter, an exclusive OR value Y₂ is obtained by taking the exclusive OR of the obtained two enciphered data y₂₁ and y₂₂, and when the two exclusive OR value Y₂ are identical, an authentication OK decision is made.

5. The authentication system according to claim 4, wherein the initial peculiar value N₀ is known to only the authentication requesting side and the authenticating side, and is non-laid-open data.

6. The authentication system according to claim 5, wherein the peculiar value N₀ is an ID (identifier) predetermined for each authentication requester.

7. The authentication system according to one of claim 1, wherein the data transfer between the authentication requesting side and the authenticating side is made via a communication line.

8. The authentication system according to claim 5, wherein the peculiar value N₀ is a peculiar value predetermined for each portable telephone set.

9. The authentication system according to claim 1, wherein the subject of authentication is a communication terminal.

10. The authentication system according to claim 1, wherein the subject of authentication is a communing party for doing communication.

11. The authentication system according to claim 1, wherein the predetermined enciphering algorithm is a one-way function operating system.

12. The authentication system according to claim 11, wherein the one-way function operating system is executed such that, denoting random numbers in two different sets by R₁ and R₂, respectively, a peculiar number by N and enciphered data by y₁ and y₂, the enciphered data y₁ and y₂ are obtained by executing
y₁=(R₂+N) mod N R₁>N and
y₂=(R₂+N) mod N R₂>N,
an exclusive OR value Y is obtained by taking the exclusive OR value Y of the obtained enciphered data y₁ and y₂, Y′ is obtained by reducing the bit number of the obtained exclusive OR value Y in a predetermined method, and it is defined that, with the random numbers R₁ and R₂ as well-known values, a calculation of obtaining Y′ from N is a forward calculation and a calculation of obtaining N from Y′ is a converse calculation, whereby although the forward calculation can be readily made, the converse calculation of obtaining N from Y′, obtained by reducing the bit number of the exclusive OR value Y in the predetermined method, is impossible because of non-existence of any calculation formula to this end, thereby preventing the tapping of or swindling on the peculiar value N.

13. An authentication system, wherein:
on an authentication requesting side, two enciphered data y₁ and y₂ are obtained with respect to random number data R₁ and R₂ in two sets, respectively, by executing a predetermined enciphering logarithm with at least one predetermined non-laid-open peculiar number N of at least two hexadecimal system bits and with one assigned to the most significant binary system bit as a parameter, an exclusive OR value Y is obtained by taking the exclusive OR of the two enciphered data y₁ and y₂, and authentication enciphered data Y′ is obtained by reducing the bit number of the obtained exclusive OR value Y in a predetermined method and transmitted together with the random number data R1 and R1 in the two sets to the authenticating side; and
on an authenticating side, two enciphered data y₁ and y₂ are obtained by executing the predetermined enciphering algorithm with the received random number data R₁ and R₂ in the two sets and a peculiar value N preliminarily registered as non-laid-open value from and based on an initial value of the same value as on the authentication requesting side as parameters, an exclusive OR value Y is obtained by taking the exclusive OR value of the obtained two enciphered data y₁ and y₂, an authentication discriminative data Y′ is obtained by reducing the bit number of the obtained exclusive OR value in the same predetermined method as on the authentication requesting side and compared with the authentication enciphered data Y′ received from the authentication requesting side, and when the two compared data Y′ are identical, an authentication OK decision is made.

14. An authentication system, wherein:
on an authentication requesting side, two enciphered data y₀₁ and y₀₂ are obtained with respect to initial random number data R₀₁ and R₀₂ in two sets, respectively, by executing a predetermined enciphering algorithm with at least one predetermined non-laid-open peculiar value N₀ of at least two hexadecimal system bits and with one assigned to the most significant binary system bit as parameter, an exclusive OR value Y₀ is obtained by taking the exclusive OR of the obtained two enciphered data y₀₁ and y₀₂, and an authentication enciphered data Y₀′ is obtained by reducing the bit number of the obtained exclusive OR value Y₀ in a predetermined method and is transmitted together with the random number data R₀₁ and R₀₂ in the two sets to the authenticating side;
on a subsequent authentication requesting side, a peculiar value N₁ is obtained by selecting either one of the two enciphered data y₀₁ and y₀₂ in a predetermined method, converting the selected data to a binary value and always assigning one to the most significant bit thereof, two enciphered data y₁₁ and y₁₂ are obtained with respect to new random number data R₁₁ and R₁₂ in two sets, respectively, by executing the predetermined enciphering method with the peculiar value N₁ as a parameter, an exclusive OR value Y₁ is obtained by taking the exclusive OR of the two enciphered data y₁₁ and y₁₂, and exclusive OR data Y₁ is obtained by reducing the bit number of the obtained exclusive OR value Yin a predetermined method and is transmitted together with the random number data R₁₁ and R₁₂ in the two sets to the authenticating side;
on the authenticating side, two enciphered data y₀₁ and y₀₂ are obtained by executing the predetermined enciphering algorithm with the received random number data R₀₁ and R₀₂ in the two sets and a peculiar value N₀ registered as non-laid-open value from and of the same value as on the authentication requesting side as parameters, an exclusive OR value Y₀ is obtained by taking the exclusive OR of the obtained two enciphered data y₀₁ and y₀₂, authentication discriminative data Y₀′ is obtained by reducing the bit number of the obtained exclusive OR value Y₀ in the same predetermined method as on the authentication requesting side and is compared with the authentication enciphering data Y₀′ received from the authentication requesting side, and when the two data are identical, an authentication OK decision is made; and
on a subsequent authenticating side, a cascade execution process is made, in which the peculiar value N₁ is obtained by selecting either one of the two enciphered data y₀₁ and y₀₂ in the same predetermined method as on the authentication requesting side, converting the selected data to a binary value and always assigning one to the most significant bit, two enciphered data y₁₁ and y₁₂ are obtained with respect to the received new random number data R₁₁ and R₁₂, respectively, with the peculiar value N₁ as a parameter, an exclusive OR value Y₁ is obtained by taking the exclusive OR of the obtained two enciphered data y₁₁ and y₁₂, authentication discriminative data Y₁′ is obtained by reducing the bit number of the obtained exclusive OR value Y₁ in the same predetermined method as on the authentication requesting side and compared with the authentication enciphered data Y₁′ received from the authentication requesting side, and when the two authentication discriminative data Y₁′ are identical, an authentication OK decision is made.

15. The authentication system according to claim 2, wherein the initial peculiar value N₀ is known to only the authentication requesting side and the authenticating side, and is non-laid-open data.

16. The authentication system according to claim 15, wherein the peculiar value N₀ is an ID (identifier) predetermined for each authentication requester.

17. The authentication system according to one of claim 2, wherein the data transfer between the authentication requesting side and the authenticating side is made via a communication line.

18. The authentication system according to one of claim 3, wherein the data transfer between the authentication requesting side and the authenticating side is made via a communication line.

19. The authentication system according to claim 15, wherein the peculiar value N₀ is a peculiar value predetermined for each portable telephone set.

20. The authentication system according to claim 2, wherein the subject of authentication is a communication terminal.

21. The authentication system according to claim 3, wherein the subject of authentication is a communication terminal.

22. The authentication system according to claim 2, wherein the subject of authentication is a communing party for doing communication.

23. The authentication system according to claim 3, wherein the subject of authentication is a communing party for doing communication.

24. The authentication system according to claim 2, wherein the predetermined enciphering algorithm is a one-way function operating system.

25. The authentication system according to claim 3, wherein the predetermined enciphering algorithm is a one-way function operating system.
